(19) United States
(12) Patent Application Publication
(10) Pub. No.: US 2026/0097896 A1
(43) Pub. Date: Apr. 9, 2026

(54) WASTE STORAGE BIN FOR THE AUTHENTICATED DELIVERY OF WASTE

(71) Applicant: ALIA SERVIZI AMBIENTALI S.P.A., Firenze (FI) (IT)

(72) Inventors: Giuseppe Roberto MARSEGLIA, Firenze (FI) (IT); Andrea GASPARETTO, Firenze (FI) (IT); Francesco PALMARINI, Firenze (FI) (IT)

(73) Assignee: ALIA SERVIZI AMBIENTALI S.P.A., Firenze (FI) (IT)

(21) Appl. No.: 19/111,948

(22) PCT Filed: Sep. 13, 2023
(86) PCT No.: PCT/IB2023/059070

§ 371 Date: Mar. 14, 2025

(30) Foreign Application Priority Data
Sep. 14, 2022 (IT) 102022000018786

(51) Int. Cl. B65F 1/16

(52) U.S. Cl. CPC B65F 1/1615

(57) ABSTRACT

The invention relates to a waste storage bin comprising a waste containment body, a lid for closing the waste storage bin and an unloading door. The container is associated with an electronic board configured to receive signals indicative of the request to open the lid to deliver one or more waste containers inside the waste storage bin. The electronic board is also configured to allow the lid to be opened following the recognition of a user enabled to deliver waste and is connected to a sensor configured to estimate the volume of the waste container delivered, and to associate the delivered volume with the enabled user.

### FIELD OF THE INVENTION

The present invention relates to a waste storage bin and in particular a waste storage bin for the authenticated delivery of waste.

### KNOWN ART

As is known, the separate collection of domestic waste has become customary in most homes; it concerns different materials, depending on the provisions or regulations issued by the local authorities where the collection is carried out. Usually, separate collection involves different materials, ranging from glass to plastic, from paper to metals, but also organic waste or other objects such as discharged batteries.

Currently, for separate domestic collection, different containers are used in homes for each type of waste, without any particular limitations or preferential choices.

The waste thus collected can be subsequently delivered by people into special waste storage bins.

Generally, the costs incurred by Municipal Administrations in relation to the collection of waste subsequently distributed to citizens through specific taxation or tariffs.

The assumption of current taxation is the possession or holding for any reason of premises or operating uncovered areas likely to produce urban waste, regardless of the amount of waste actually produced.

Therefore, an object of the present invention is to provide a system which is capable of proposing a taxation or tariff of the waste collection based on the actual volume of the waste produced.

A further object of the present invention is to provide a waste storage bin for the authenticated delivery of waste, the operation of which can be controlled remotely.

A not least object of the invention is to obtain the above-mentioned results in a practical and economical manner.

### SUMMARY OF THE INVENTION

The above objects are achieved thanks to a waste storage bin for the authenticated delivery of waste, said waste storage bin comprising a waste containment body, a lid for closing the waste storage bin and an unloading door, wherein said waste storage bin is associated with an electronic board configured to receive signals indicative of the request to open said lid to deliver one or more waste containers inside said waste storage bin, and wherein said electronic board is configured to allow the lid of the waste storage bin to be opened following the authentication of a user enabled to deliver waste and wherein said electronic board is connected to a sensor configured to estimate the volume of the waste container delivered in the waste storage bin and is configured to associate the delivered volume with said enabled user.

An advantage of the invention is that it makes it possible to associate the volume of waste delivered with each individual user and possibly arrange taxation or tariffs based on the volume of waste actually produced by the user and delivered to the waste storage bin.

According to an embodiment of the present invention, the electronic board comprises a first processor, with very low power consumption, which has the task of constantly monitoring a plurality of sensors which are responsible for activating any alarms in real time, wherein such sensors, indicatively but not exclusively, comprise an accelerometer, a battery charge sensor, an ultrasonic sensor for verifying that the waste storage bin is full, a temperature sensor, a sensor for verifying the opening of the unloading door of the waste storage bin, a sensor for verifying the opening of the lid of the waste storage bin and a sensor for verifying the opening of a lock of the lid of the waste storage bin.

An advantage of this embodiment is that it allows to provide real-time information on the operation of the waste storage bin for the authenticated delivery of waste.

According to a further embodiment of the present invention, the electronic board comprises a second processor which has the task of managing the waste delivery logic, managing the display of data, carrying out communication to a remote server and carrying out any intensive arithmetic operations and recording, where necessary, data in local memories.

According to another embodiment of the present invention, the electronic board (main electronic board) is associated with a first auxiliary electronic board which envisages a GNSS module and a second auxiliary electronic board that envisages a module for wireless connection to a remote server, wherein said auxiliary boards are removably connected to the electronic board by means of connectors. It should be noted that the first and the second processor are only located inside the main electronic board.

According to yet another embodiment of the present invention, the estimation of the waste volume is obtained by means of a sensor based on ToF (Time of Flight) technology which reconstructs in three dimensions, through the use of a proprietary algorithm, the contents of the waste storage bin, then geometrically measuring the difference in volume occupied or free in the waste storage bin, before and after delivery.

Further features of the invention can be inferred from the dependent claims.

### BRIEF DESCRIPTION OF THE FIGURES

Further features and advantages of the invention will be apparent from reading the following disclosure provided by way of non-limiting example, with the help of the figures illustrated in the attached tables, in which:

FIG. 1 schematically illustrates a waste storage bin for the delivery of waste, according to an embodiment of the present invention;

FIG. 2 schematically illustrates a control panel of the waste storage bin of FIG. 1;

FIG. 3 schematically illustrates a key provided with an RFID tag which can be used with the waste storage bin of FIG. 1;

FIG. 4 schematically illustrates a main electronic board and two auxiliary electronic boards, used to manage the waste storage bin of FIG. 1;

FIG. 5 illustrates a first processor belonging to the main electronic board and the main components connected thereto; and

FIG. 6 illustrates a second processor belonging to the main electronic board and the main components connected thereto.

### DETAILED DESCRIPTION OF THE FIGURES

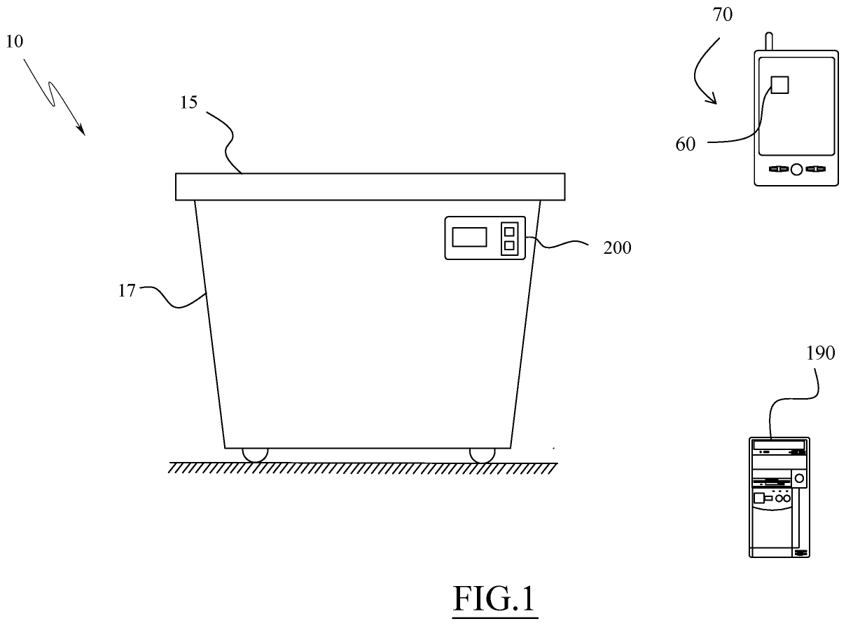

The invention will now be described with particular reference to the attached figures, wherein in FIG. 1 a waste storage bin for the delivery of waste is visible, according to an embodiment of the present invention, globally indicated with the reference numeral 10.

The waste storage bin 10 for the delivery of waste comprises a waste containment body 17 and a lid 15 for closing the waste storage bin.

The waste storage bin 10 is associated with an electronic board 20 configured to receive signals indicative of a request to open the lid 15 to deliver one or more waste containers inside the waste storage bin 10.

According to an embodiment of the present invention, the electronic board 20 is configured to allow the lid 15 of the waste storage bin 10 to be opened following the authentication of a user enabled to deliver waste.

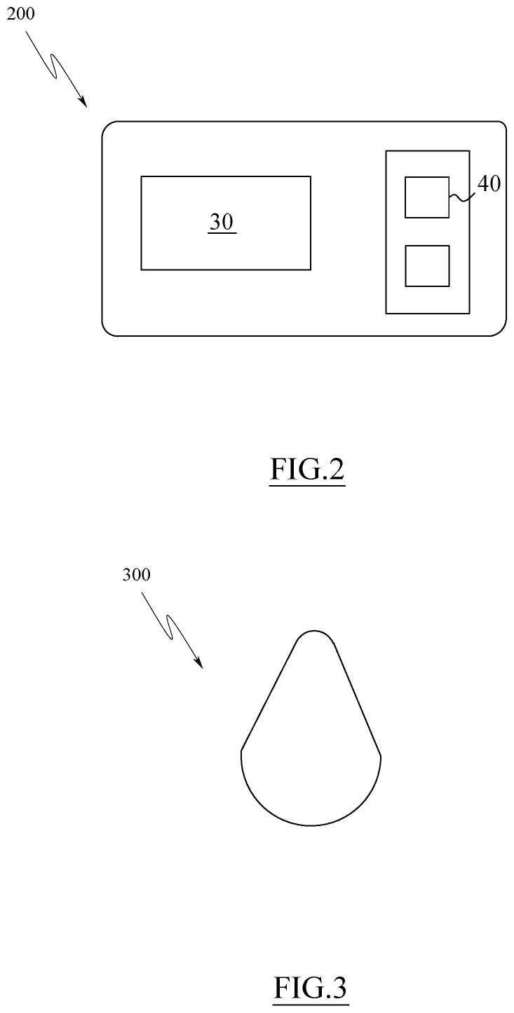

In particular, referring to FIG. 2, which schematically illustrates a control panel 200 of the waste storage bin 10 of FIG. 1, to open the lid 15 of the waste storage bin 10, the user approaches their key 300, provided with an RFID tag, to an NFC reader 40 of the control panel 200, possibly following instructions depicted on a display 30.

Thereafter, the electronic board 20 recognises the enabled user, stores the identification data in a memory 100′, and opens the lid 15 to allow the user to deliver one or more waste containers into the waste storage bin 10.

In addition to this mode, the electronic board 20 may allow user authentication using an application 60 for smart devices, in particular smartphones 70, tablets or the like, and the use of Bluetooth as a communication technology.

Furthermore, the electronic board 20 is connected to a sensor 180 configured to estimate the volume of the waste container delivered into the waste storage bin and is configured to associate the delivered volume with the enabled user.

According to an aspect of the invention, the estimation of the volume of the waste is obtained by means of a sensor based on ToF (Time of Flight) technology, i.e., an optical distance estimation system which reconstructs in three dimensions, through the use of a proprietary algorithm, the contents of the waste storage bin, then geometrically measuring the difference in volume occupied or free in the waste storage bin 10, before and after delivery. The sensor is calibrated to be able to reconstruct with an adequate resolution the contents of all the waste containers adopted by the system.

It is thereby possible to associate the volume of waste delivered with each individual user and possibly arrange taxation or tariffs based on the volume of waste actually produced by the user and delivered to the waste storage bin.

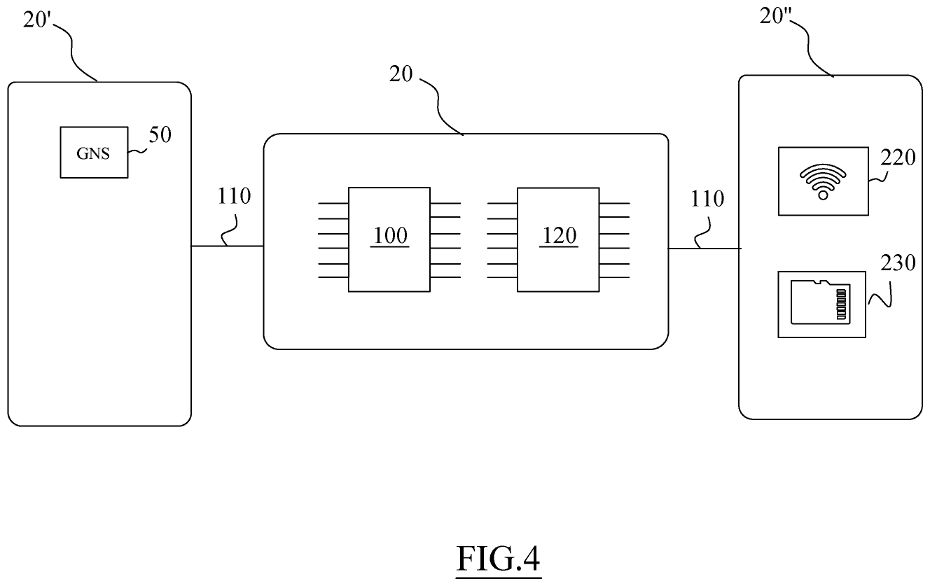

As visible in FIG. 4, the electronic board 20 comprises a first processor 100, with very low power consumption, which has the task of constantly monitoring a plurality of sensors which are responsible for activating any alarms in real time.

The electronic board 20 further comprises a second processor 120, provided with a memory 120′ thereof, which has the task of managing the waste delivery logic, or in particular the allocation of the volumes of waste delivered to the respective users, of managing the display of data on the display 30, and of carrying out communication to a remote server 190 (or a cloud) and of carrying out any intensive arithmetic operations on the collected data and recording, where necessary, data in local memories.

Furthermore, a first auxiliary electronic board 20′ which envisages a GNSS module 50 and a second auxiliary electronic board 20″ which envisages a module 220 for wireless connection to the remote server 190 are associated with the main electronic board 20.

Alternatively, the connection with remote server 190 can be made using the GSM/LTS system and a related SIM 230.

As is known, the term GNSS (Global Navigation Satellite System) describes any constellation of satellite that provides positioning, navigation and time measurement services on a global or regional basis such as GPS system or, for example, GLONASS, BEIDOU, GALILEO, A-GPS, QZSS or other systems.

The GNSS module 50 can be used to know the position of the waste storage bin 10 and, in particular, to check whether the waste storage bin 10 has been moved.

The auxiliary boards 20′, 20″ are removably connected to the electronic board 20 by means of connectors 110.

This offers the possibility of removing said auxiliary boards in the event of damage or update of the specific module. For example, if it is decided to switch to LoRa technology for communication, a modem will simply need to be installed instead of changing the entire board. In other words, the waste storage bin 10 is configured so that an auxiliary electronic board, or both auxiliary electronic boards 20′ and 20″, can be replaced with an identical electronic board or with a different electronic board. This can be extremely advantageous for reconfiguring the waste storage bin 10 with updated features or with totally new features, e.g. with regard to remote communication, geolocation of the waste storage bin 10, or other. It should be noted that the removal of one or more auxiliary electronic boards 20′ 20″ does not in any way affect the basic operations of the waste storage bin 10 since both the first processor 100 and the second processor 120 are located on the main electronic board 20 from which the two auxiliary boards 20′ 20″ can be removed (and reconnected). Thereby, if even one of the two auxiliary boards 20′, 20″ were to be damaged, the waste storage bin 10 would continue to operate (of course with limited functionalities) pending repair or the arrival of a replacement board.

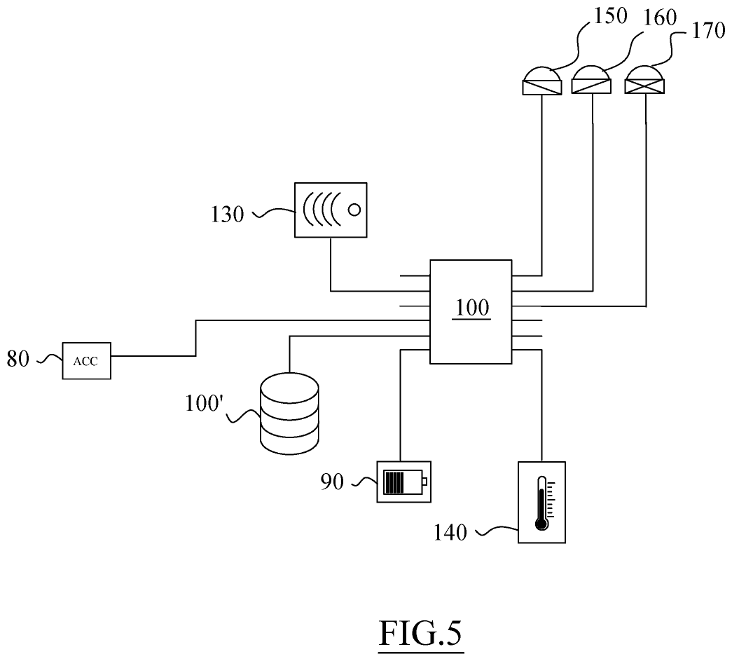

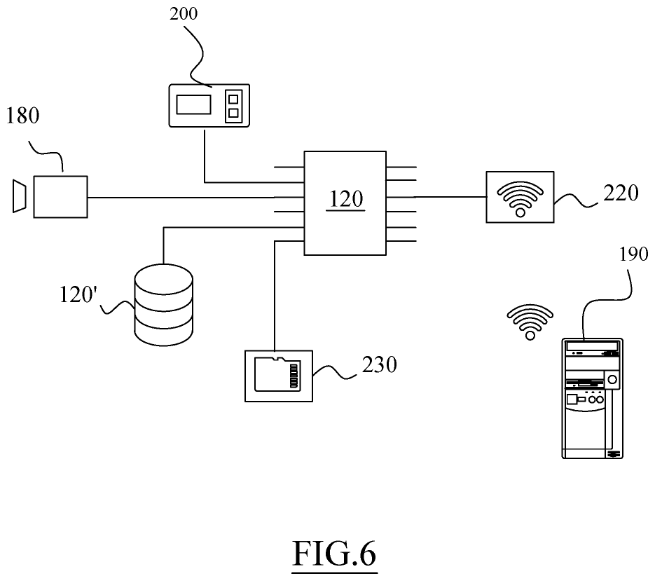

As visible in FIG. 5, the first processor 100 belonging to the main electronic board 20 is connected to a plurality of sensors, which can inter alia be used to detect abnormal conditions of the waste storage bin 10.

Such sensors comprise an accelerometer 80, which can be used to signal a collision or tipping condition of the waste storage bin 10, a battery charge sensor 90, an ultrasonic sensor 130 for verifying if the waste storage bin is full.

For example, the waste storage bin 10 can comprise a motion sensor which is controlled by the first processor 100 to send a signal indicative of a tipping and/or collision of the waste storage bin 10 in real time. It is thereby possible to carry out timely maintenance of the waste storage bin 10.

In particular, the electronic board uses a rechargeable battery pack, for example by means of solar panels, with a maximum voltage of 16.8 V and a capacity of 6000 mAh.

It is also possible to accommodate a larger capacity battery pack. For the management of energy consumption and alarms, the following thresholds have currently been set:
Voltage less than 14.0 V low voltage alarm
Voltage of 13.2 V connection suspension and local buffering of events while waiting to be recharged
Voltage below 13.0 V, the system does not close the waste storage bin at the end of the cycle so that if the board cannot be turned on again the user can deliver.

These thresholds and operating logics can be changed. For the purposes of energy consumption, an autonomy of at least 90 days must be considered without any replenishment of current by the solar panel.

A temperature sensor 140, trained by artificial intelligence to detect possible fires inside the waste storage bin 10, a sensor 150 for verifying the opening of the unloading door of the waste storage bin 10, a sensor 160 for verifying the opening of the lid 15 of the waste storage bin 10 and a sensor 170 for verifying the opening of a lock of the lid 15 of the waste storage bin 10 are further envisaged.

The sensors listed above continuously acquire data thanks to the support of the low-power consumption processor 100. If the value read by a given sensor exceeds a target value, such as a specific threshold or a study of the trend of the metric, the processor 100 activates the processor 120 which connects to immediately send the signal to a cloud system.

The electronic board, in addition to accumulating data to detect any anomalies, collects them within its internal memory in the form of time series which will be stored in the cloud at each connection.

The acquisition of a detailed history on the operation of the board (for example, precise data on temperatures or battery charge percentages), allows to feed any systems based on artificial intelligence (AI) which allows predictive maintenance interventions before the end customer reports the malfunction.

It should be noted that alarm messages have the highest priority and are communicated to the cloud as soon as they occur, while for all other data it waits for a communication window, (for example every 4 hours, a value which can however be configured), limiting unjustified consumption thanks to this.

In the operation of the system, once the user approaches the waste storage bin 10, the user approaches their key 300 to the NFC reader 40 near the screen 30.

The communication of credentials is protected by encryption, to ensure the arbitrage security.

The electronic board 20 reads the identity of the user and, having verified the authorisation to deliver, enables the latter by unlocking the lock, guiding the user through some explanatory screens which will appear on the screen 30.

Once the lid 15 of the waste storage bin 10 is closed, the information related to the delivery is prepared to be sent to the remote server 190 in the cloud.

The information which is collected is:
User identity
Delivery date and time
Delivery duration
Level of the contents of the waste storage bin after delivery
Outcome of the delivery
Type of waste

The personnel managing the waste storage bin 10 also have at their disposal a series of customised RFID tags which allow them to initiate diagnostic routines on the devices in the event of malfunctions.

In a further aspect of the invention, a waste management method using the above-described waste storage bin 10 is envisaged. The method comprises:
receiving signals indicative of the request to open the lid 15 to deliver one or more waste containers inside the waste storage bin 10;
allowing the lid 15 of the waste storage bin 10 to be opened following the authentication of a user enabled to deliver waste; and
estimating the volume of the waste container delivered in the waste storage bin 10 and associating the delivered volume with the enabled user.

It should be noted that all the applications and technical features related to the waste storage bin 10 have been similarly associated with said waste management method.

For example, the method further comprises sending a signal indicative of a tipping and/or a collision of the waste storage bin 10 in real time to allow an appropriate maintenance activity.

The method further comprises sending a fill signal of the waste storage bin 10 in real time and enabling on-demand emptying schemes.

The method further comprises managing a list of unwanted users (black-list) which can no longer deliver in said waste storage bin 10. Thereby, users can be selected based on their commitment to comply with the waste management rules, for example in the event of vandalism. Thanks to the identification system, the waste storage bin 10 is configured to prevent the lid 15 from being opened for users in the list. Advantageously, the list can be sent by means of message to the competent authorities.

The method further comprises the association of a single delivery to a specific user, for example on the waste tax, enabling fee-based tariff schemes (pay-as-you throw).

The invention as described can be modified or improved for contingent or particular reasons, without departing from the scope of the invention.

1. A waste storage bin for the authenticated delivery of waste, wherein said waste storage bin comprises a waste containment body, a lid for closing the waste storage bin and an unloading door, wherein said waste storage bin is associated with an electronic board configured to receive signals indicative of the request to open said lid to deliver one or more waste containers inside said waste storage bin, and wherein said electronic board is configured to allow the lid of the waste storage bin to be opened following the authentication of a user enabled to deliver waste and wherein said electronic board is connected to a sensor configured to estimate the volume of the waste container delivered in the waste storage bin and is configured to associate the delivered volume with said enabled user.

2. The waste storage bin as in claim 1, wherein said electronic board is associated with a control panel placed in a position accessible to users, wherein said control panel comprises a display and a reader configured to authenticate users enabled to deliver waste into the waste storage bin.

3. The waste storage bin as in claim 2, wherein the reader is an NFC reader and the user is identified by means of a key containing an RFID tag which is passed over the NFC reader and wherein the communication of the credentials is encrypted.

4. The waste storage bin as in claim 2, wherein the reader is a Bluetooth reader and the user is authenticated using an application for smart devices, in particular smartphones, tablets or the like.

5. The waste storage bin as in claim 1, wherein said electronic board comprises a first processor with very low power consumption, which has the task of constantly monitoring a plurality of sensors which are responsible for activating any alarms in real time, wherein such sensors comprise an accelerometer, a battery charge sensor, an ultrasonic sensor for verifying that the waste storage bin is full, a temperature sensor, a sensor for verifying the opening of the unloading door of the waste storage bin, a sensor for verifying the opening of the lid of the waste storage bin and a sensor for verifying the opening of a lock on the lid of the waste storage bin.

6. The waste storage bin as in claim 1, wherein said electronic board comprises a second processor which has the task of managing the waste delivery logic, managing the display of data, carrying out communication to a remote server and carrying out any intensive arithmetic operations and recording, where necessary, data in local memories.

7. The waste storage bin as in claim 1, wherein said electronic board is associated with a first auxiliary electronic board which envisages a GNS module and a second electronic board which envisages a module for wireless connection to a remote server wherein said auxiliary boards are removably connected to the electronic board by means of connectors.

8. The waste storage bin as in claim 1, wherein the estimation of the waste volume is obtained by means of a sensor based on ToF (Time of Flight) technology which reconstructs in three dimensions, through the use of a proprietary algorithm, the contents of the waste storage bin, then geometrically measuring the difference in volume occupied or free in the waste storage bin, before and after delivery.

9. The waste storage bin as in claim 2, wherein keys provided with RFID tags are envisaged which can be personalised and used to initiate diagnostic procedures by the personnel managing the waste storage bin.

10. The waste storage bin according to claim 5, comprising a motion sensor which is controlled by the first processor to send a signal indicative of a tipping and/or an impact of the waste storage bin in real time.

11. A waste management method by means of the use of the waste storage bin according to claim 1, wherein the method comprises:
receiving signals indicative of the request to open the lid to deliver one or more waste containers inside the waste storage bin,
allowing the lid of the waste storage bin to be opened following the authentication of a user enabled to deliver waste; and
estimating the volume of the waste container delivered in the waste storage bin and associating the delivered volume with the enabled user.

12. The method as in claim 11, further comprising sending a signal indicative of a tipping and/or impact of the waste storage bin in real time to allow an appropriate maintenance activity.

13. The method as in claim 11, further comprising sending a fill signal of the waste storage bin in real time and enabling on-demand emptying schemes.

14. The method as in claim 11, further comprising managing a list of unwanted users who can no longer deliver in said waste storage bin.

15. The method as in claim 11, further comprising the association of a single delivery to a specific user, for example on the waste tax, enabling fee-based tariff schemes.
